(19) United States
(12) Patent Application Publication
(10) Pub. No.: US 2025/0007400 A1
(43) Pub. Date: Jan. 2, 2025

(54) POWER CONVERSION DEVICE

(71) Applicant: SHANGHAI METAPWR ELECTRONICS CO., LTD, Shanghai (CN)

(72) Inventor: Jianhong ZENG, Shanghai (CN)

(73) Assignee: SHANGHAI METAPWR ELECTRONICS CO., LTD, Shanghai (CN)

(21) Appl. No.: 18/757,463

(22) Filed: Jun. 27, 2024

(30) Foreign Application Priority Data
Jun. 30, 2023 (CN) 202310791457.8

(51) Int. Cl. H02M 3/155; H02M 3/00

(52) U.S. Cl. CPC H02M 3/155; H02M 3/003

(57) ABSTRACT

The application discloses a power conversion device. The power conversion device comprises a transformer assembly, a switch, an output capacitor and a driving unit, and the conversion efficiency of the power conversion device is optimized; On the other hand, the application discloses a layout of the power conversion device; The layout comprises a transformer area, a switch area, an output capacitor area and a port area layout, and the conversion efficiency of the power conversion device is further improved through reasonable layout; and on the other hand, the application discloses a current sampling scheme suitable for the power conversion device is disclosed, and a control pin is multiplexed in a time-sharing mode, so that comprehensive detection and monitoring of the current of the power conversion device and the current sharing function of the plurality of power conversion devices in parallel application are achieved.

### CROSS-REFERENCE TO RELATED APPLICATION

This application claims the priority benefit of China application no. 202310791457.8, filed on Jun. 30, 2023. The entirety of the above-mentioned patent application is hereby incorporated by reference herein and made a part of this specification.

### BACKGROUND

With the development of artificial intelligence, the power requirements of an artificial intelligence data processing chip, such as a CPU, a GPU, a TPU and the like (collectively, XPU) are higher and higher, so that the power of the server is increased, the power supply voltage of the server system board rises from 12V to 48V. The power supply voltage of the server system board is 48V, and the two-stage voltage reduction circuit architecture gradually becomes mainstream.

The intermediate bus conversion device in the two-stage buck circuit architecture is used for realizing voltage conversion between an input bus and an output bus, and the ratio of the input voltage to the output voltage is a fixed gain ratio or an unfixed gain ratio. In an intermediate bus conversion device having a fixed gain ratio, the input voltage in the range of 40-60 V of the server mainboard is reduced to the output voltage according to the proportion of 4:1 or 8:1 or 12:1, and the voltage regulator load for supplying power to the artificial intelligence chip is supplied. As the power consumption on the server mainboard becomes larger and larger, the power required to be provided by the intermediate bus conversion device with the fixed gain ratio is increasingly larger, and the requirements for power density and conversion efficiency are higher and higher.

The application provides a solution of a power conversion device for fixed gain ratio output with high power density and high conversion efficiency. The solution comprises a driving circuit of the power switch and a layout of the power conversion device.

### SUMMARY

The application provides a power conversion device which comprises a circuit substrate, a transformer assembly, a switch, an output capacitor, an input positive end, an output positive end and an output negative end;
wherein the circuit substrate comprises a first surface and a second surface which are opposite to each other, and the first surface comprises a transformer area, a switch area, an output capacitor area and a first port area;
wherein the transformer assembly is arranged in the transformer area, the switch is arranged in the switch area, at least one part of the output capacitor is arranged in the output capacitor area, and the input positive end, the output positive end and the output negative end are arranged in the first port area;
wherein the transformer area, the switch area, the output capacitor area and the first port area are arranged in the same direction.

Preferably, the output positive end comprises at least two output positive-end gold fingers, the output negative end comprises at least two output negative-end gold fingers, and the output positive-end gold fingers and the output negative-end gold fingers are arranged in the first port area in a staggered mode.

Preferably, the power conversion device further comprises a signal end, the signal end comprises at least two signal end gold fingers, and the signal end gold fingers are arranged on one side of the port area.

Preferably, the switch comprises two middle switches and two lower switches, the two lower switches are arranged between the two middle switches, and the middle switches and the lower switches are arranged adjacent to the transformer area.

Preferably, the switch further comprises two upper switches, and the two upper switches are respectively arranged adjacent to one of the middle switches.

Preferably, the power conversion device further comprises a lower switch driving area and two middle-upper switch driving areas, and the two middle-upper switch driving areas are arranged on the two opposite sides of the switch area respectively and are adjacent to the middle switch and/or the lower switch.

Preferably, the power conversion device further comprises a driving unit, the driving unit comprises a driving magnetic piece, a lower switch driving unit, a middle switch driving unit and an upper switch driving unit, wherein the driving magnetic piece and the lower switch driving unit are arranged in the lower switch driving area, and the middle switch driving unit and the upper switch driving unit are arranged in the middle-upper switch driving area.

Preferably, the second surface comprises a signal area and a second port area, wherein the output positive-end gold finger and the output negative-end gold finger are arranged in a second port area of the second surface in a staggered mode; at least one output positive-end gold finger arranged on the second surface at least partially coincides with at least one corresponding output positive-end gold finger arranged on the first surface; and at least one output negative end golden finger arranged on the second surface at least partially coincides with at least one corresponding output negative end golden finger arranged on the first surface.

Preferably, the second surface comprises a switch region, wherein the switch further comprises two other middle switches and another two lower switches, the other two middle switches and the other two lower switches are arranged in a switch region of the second surface, and the projection of the at least one middle switch or the lower switch of the second surface switch region on the first surface at least partially coincides with the projection of the corresponding middle switch or the corresponding lower switch arranged on the first surface on the first surface.

Preferably, the second surface comprises an output capacitor area, wherein at least a part of the output capacitor is arranged in an output capacitor area of the second surface, and the projection of the output capacitor arranged on the second surface is partially or completely in the output capacitor area of the first surface.

Preferably, the first surface and/or the second surface comprise a resonant capacitor area, and the resonant capacitor area is adjacent to one of the middle switches or one of the upper switches.

A power conversion device comprises a power conversion circuit, a driving unit and a control signal;
wherein the power conversion circuit comprises an input positive end, an input negative end, an output positive end and an output negative end, and the input negative end and the output negative end are short-circuited; the power conversion circuit comprises a three-switch bridge arm, the three-switch bridge arm comprises a first upper switch, a first middle switch and a first lower switch which are electrically connected in series, the first upper switch is electrically connected with the input positive end, the first upper switch and the first middle switch are electrically connected to the first upper node, and the first middle switch and the first lower switch are electrically connected to the first lower node; the power conversion circuit further comprises a second lower switch, and the first lower switch and the second lower switch are electrically connected with the input negative end;
wherein the control signal comprises a first control signal, a second control signal, a third control signal and a fourth control signal;
wherein the driving unit comprises a driving magnetic piece, an upper switch driving unit, a middle switch driving unit and a lower switch driving unit; the lower switch driving unit receives a first control signal, a second control signal, a third control signal and a fourth control signal; the lower switch driving unit outputs a lower switch driving signal for driving the two lower switches to be turned-on and turned-off; and the lower switch driving unit is electrically connected with the driving magnetic piece; the middle switch driving unit receives a control signal through the driving magnetic piece, and the middle switch driving unit outputs a middle switch driving signal to drive the two middle switches to be turned-on and turned-off; and the upper switch driving unit receives a control signal through the driving magnetic piece, and the upper switch driving unit outputs an upper switch driving signal to drive the two upper switches to be turned-on and turned-off.

Preferably, the lower switch driving unit comprises a driving power supply positive end, a grounding end, a first lower switch driving output end and a second lower switch driving output end, wherein the lower switch driving unit further comprises four control switches, the four control switches are electrically connected into a full-bridge structure and are bridged between the driving power supply positive end and the grounding end of the driving power supply, and the first lower switch driving output end and the second lower switch driving output end are respectively two bridge arm midpoint; and the four control switches are respectively controlled by a first control signal, a second control signal, a third control signal and a fourth control signal.

Preferably, the driving magnetic piece comprises a driving winding, a first middle winding and a first upper winding, wherein the driving winding, the first middle winding and the first upper winding are wound on the same magnetic core, and the driving winding is bridged between the first lower switch driving output end and the second lower switch driving output end.

Preferably, the middle switch driving unit comprises two middle driving switches, wherein the drains of the two middle driving switches are electrically connected with the two ends of the first middle winding respectively, and the sources of the two middle driving switches are short-circuited to the first lower node; one end of the first middle winding and the first lower node form a first middle switch driving output end; and the voltage between any end of the first middle winding and the first lower node is used for controlling a middle driving switch electrically connected with the other end of the first middle winding.

Preferably, the upper switch driving unit comprises two upper driving switches, wherein the drains of the two upper driving switches are electrically connected with the two ends of the first upper winding respectively, and the sources of the two upper driving switches are connected to the first upper node; one end of the first upper winding and the first upper node form a first upper switch driving output end; and the voltage between any end of the first upper winding and the first upper node is used for controlling an upper driving switch electrically connected with the other end of the first upper winding.

A power conversion device comprises a power conversion circuit, a pre-charging unit, a sampling resistor and a sampling circuit unit;
wherein the power conversion circuit comprises an input positive end, an input negative end, an output positive end, an output negative end and an output capacitor, the input negative end and the output negative end are short-circuited, and the output capacitor is bridged between the output positive end and the output negative end;
wherein the sampling circuit unit is used for sampling a working current of the power conversion circuit;
wherein the pre-charging unit comprises a switch end, an inductor end and a grounding end, the switch end is electrically connected with the input positive end, the inductor end is electrically connected with the output positive end through the sampling resistor, and the grounding end is electrically connected with the input negative end; the pre-charging unit pre-charges the output capacitor;
wherein the sampling resistor is used for sampling an outflow current of the pre-charging unit.

Preferably, that the power conversion circuit further comprises two lower switches and two low-voltage windings; wherein the first ends of the two low-voltage windings are electrically connected to the output positive end, and the second end of each low-voltage winding is electrically connected with one end of one of the two lower switches to form two lower nodes; and the other end of the two lower switches is electrically connected to the output negative end.

Preferably, the sampling circuit unit comprises three sampling ends, a reference end, a sampling output positive end and a sampling output negative end, wherein two sampling ends of the three sampling ends are electrically connected with a corresponding lower node, the other sampling end of the three sampling ends is electrically connected with the output positive end, and the reference end is electrically connected with the output positive end.

Preferably, the sampling circuit unit further comprises three sampling resistors, a sampling capacitor, an impedance matching resistor and an amplifying unit; wherein the first ends of the three sampling resistors are electrically connected to the midpoint of the sampling resistors, and the second end of each sampling resistor is electrically connected with one sampling end; the sampling capacitor and the impedance matching resistor are electrically connected between the reference end and the midpoint of the sampling resistor in series; the amplifying unit comprises two input ends and two output ends, the two input ends are electrically connected with the two ends of the sampling capacitor respectively, and the two output ends are electrically connected with the sampling output positive end and the sampling output negative end respectively.

Preferably, the pre-charging unit further comprises two pre-charging switches, a pre-charging inductor, a pre-charging capacitor and a pre-charging diode; wherein the two pre-charging switches are electrically connected in series between the switch end and the grounding end; one end of the pre-charging inductor is electrically connected with a series connection point of the two pre-charging switches, and the other end of the pre-charging inductor is electrically connected with the positive electrode of the pre-charging diode and the positive end of the output capacitor; the negative electrode of the pre-charging diode is electrically connected with the inductor end; and the negative end of the output capacitor is electrically connected with the grounding end.

Preferably, when the terminal voltage across the output capacitor reaches a predetermined voltage, the pre-charging unit stops working, and the predetermined voltage is greater than 70% of the output steady-state voltage Vo_normal of the power conversion circuit.

A power conversion device comprises a power conversion circuit, a controller, a gating circuit, a current sharing circuit unit, an address circuit unit and a starting control signal;
wherein the gating circuit comprises two input ends, a control end and an output end, the two input ends are electrically connected with the current sharing circuit unit and the address circuit unit respectively, the output end is electrically connected with the controller, and the control end receives the starting control signal;
wherein the controller is used for controlling the power conversion circuit;
wherein the starting control signal controls the gating circuit, and the voltage of the current sharing circuit unit or the voltage of the address circuit unit is sent to the controller through the gating circuit.

Preferably, the power conversion device further comprises a current source;

When the starting control signal is at a low level, the current source charges the address circuit unit, and the voltage of the address circuit unit is sent to the controller through the gating circuit;

When the starting control signal is at a high level, the current source charges the current sharing circuit unit, and the voltage of the current sharing circuit unit is sent to the controller by means of the gating circuit.

Preferably, the power conversion device comprises a grounding end; wherein the current sharing circuit unit comprises a current sharing resistor, a current sharing capacitor and a current sharing switch; the current sharing resistor and the current sharing capacitor are electrically connected between one input end of the gating circuit and the current sharing switch in parallel, one end of the current sharing switch is electrically connected with the grounding end, and the other end of the current sharing switch is electrically connected with the current sharing resistor and the current sharing capacitor; and the current sharing switch is controlled by the starting control signal.

Preferably, the power conversion device comprises a grounding end, wherein the address circuit unit comprises an address resistor and an address capacitor, and the address resistor and the address capacitor are electrically connected in parallel between one input end of the gating circuit and the grounding end.

A power conversion device comprises a power conversion circuit, a dummy load unit, a power supply voltage and a dummy load control signal;
wherein the power conversion circuit comprises an input positive end, an input negative end, an output positive end and an output negative end, and the input negative end and the output negative end are short-circuited;
wherein the power conversion circuit further comprises an input capacitor and an output capacitor, the input capacitor is bridged between the input positive end and the output positive end, and the output capacitor is bridged between the output positive end and the output negative end;

One end of the dummy load unit is electrically connected to the power supply voltage, and the other end is electrically connected to the output positive end;
wherein the dummy load control signal controls the dummy load unit to discharge the output positive end.

Preferably, when the dummy load control signal is at a low level, the dummy load unit is switched into the power conversion device; and when the dummy load control signal is at a high level, the dummy load unit is cut out from the power conversion device.

Preferably, the power conversion device further comprises a starting control signal and a preset voltage; wherein when the starting control signal of the power conversion device is at a high level, the dummy load control signal is at a high level; when the starting control signal of the power conversion device is at a low level and the output voltage of the power conversion device is greater than or equal to the preset voltage, the dummy load control signal is at a high level; and when the starting control signal of the power conversion device is at a low level, and the output voltage of the power conversion device is smaller than the preset voltage, the dummy load control signal is at a low level.

Preferably, the dummy load unit comprises a power supply end, a grounding end, a first dummy load control switch, a second dummy load control switch, a dummy load amplifying switch, a first current limiting resistor, a second current limiting resistor, a third current limiting resistor and a fourth current limiting resistor; wherein the first current limiting resistor and the first dummy load control switch are connected in series between the power supply end and the grounding end, and the gate electrode of the first dummy load control switch is electrically connected with the dummy load control signal; the second current limiting resistor, the second dummy load control switch and the third current limiting resistor are connected in series between the power supply end and the grounding end, and the gate electrode of the second dummy load control switch is electrically connected with the drain electrode of the first dummy load control switch; the dummy load amplifying switch and the fourth current limiting resistor are connected in series between the output positive end and the grounding end of the power conversion device, and the base electrode of the dummy load amplifying switch is electrically connected with the source electrode of the second dummy load control switch.

Preferably, the dummy load unit comprises a dummy load amplifying switch and a current limiting resistor, wherein the dummy load amplifying switch is electrically connected to an output positive end of the power conversion device, the dummy load control signal is used for controlling the dummy load amplifying switch to be turned on and turned off, and the current limiting resistor is used for controlling the current flowing through the dummy load amplifying switch.

The beneficial effects of the application are that the conversion efficiency is improved by optimizing the layout of the power device of the power conversion device; by improving the driving circuit, the current comprehensive detection and overcurrent protection in the operation process of the power conversion device are realized by adding the current sampling function to the pre-charging unit, and the current sharing or current reporting function of the plurality of power conversion devices in parallel application is realized under the condition that the number of pins is limited through time division multiplexing of the address function of the power management bus or one pin of the microprocessor.

### BRIEF DESCRIPTION OF THE DRAWINGS

FIG. 1 is a topological schematic diagram of a power conversion circuit;

FIG. 2A and FIG. 2B are schematic circuit diagrams of a power conversion device and a current sampling unit;

FIG. 2C is a schematic circuit diagram of another current sampling unit;

FIG. 3A is a schematic diagram of a driving unit of a power conversion device;

FIG. 3B, FIG. 3C and FIG. 3D are control timing diagrams used by the power conversion device;

FIG. 4 is a schematic diagram of a dummy load unit used by a power conversion device;

FIG. 5 is a schematic diagram of a time-division multiplexing function in a power conversion device;

FIG. 6A, FIG. 6B, FIG. 6C and FIG. 6D are schematic layout diagrams of a power conversion device.

### DESCRIPTION OF THE EMBODIMENTS

The present application discloses various embodiments or examples of implementing the thematic technological schemes mentioned. To simplify the disclosure, specific instances of each element and arrangement are described below. However, these are merely examples and do not limit the scope of protection of this application. For instance, a first feature recorded subsequently in the specification formed above or on top of a second feature may include an embodiment where the first and second features are formed through direct contact, or it may include an embodiment where additional features are formed between the first and second features, allowing the first and second features not to be directly connected. Additionally, these disclosures may repeat reference numerals and/or letters in different examples. This repetition is for brevity and clarity and does not imply a relationship between the discussed embodiments and/or structures. Furthermore, when a first element is described as being connected or combined with a second element, this includes embodiments where the first and second elements are directly connected or combined with each other, as well as embodiments where one or more intervening elements are introduced to indirectly connect or combine the first and second elements.

One of the cores of the present application is to provide a power conversion device comprising a transformer assembly, a switch, an output capacitor and a driving unit. By optimizing the driving unit, the turn-off loss of the switch is reduced, and the conversion efficiency of the power conversion device is optimized.

The application further provides a layout of the power device of the power conversion device. The layout of the power device of the power conversion device comprises the layout of a transformer area, a switch area, an output capacitor area and a port area, and the conversion efficiency of the power conversion device is further improved through reasonable layout.

The application further provides a current sampling scheme suitable for the power conversion device, and comprehensive detection and overcurrent protection of current in the operation process of the power conversion device are achieved. Through one control pin of the time division multiplexing controller or the microprocessor, the address function of the power management bus is achieved, and the current sharing or current reporting function during parallel application of the multiple power conversion devices is achieved.

The technical solutions in the embodiments of the present disclosure will be clearly and completely described below with reference to the accompanying drawings in the embodiments of the present disclosure. Obviously, the described embodiments are only a part but not all of the embodiments of the present application. All other embodiments obtained by a person of ordinary skill in the art based on the embodiments of the present application without creative efforts shall fall within the protection scope of the present application.

### Embodiment 1

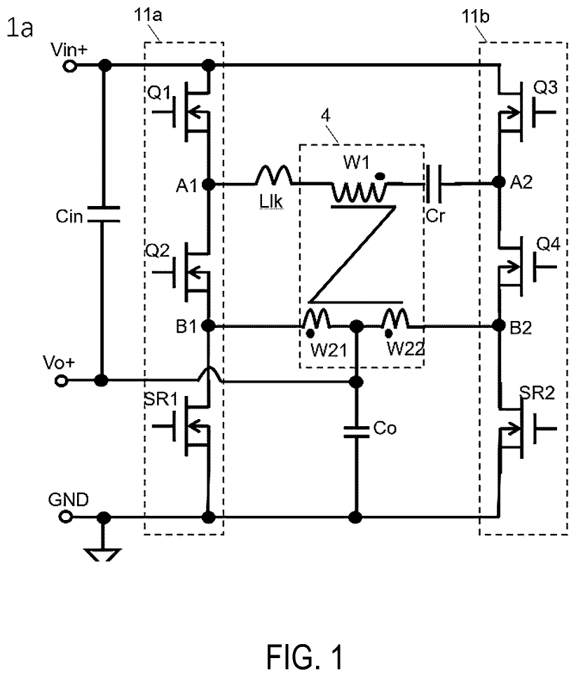

The schematic diagram of the power conversion circuit 1a disclosed by the application is as shown in FIG. 1, the power conversion circuit 1a comprises an input terminal and an output terminal. The input terminal comprises an input positive end Vin+ and an input negative end Vin−. The output terminal comprises an output positive end Vo+ and an output negative end Vo−. In this embodiment, the input negative end Vin− and the output negative end Vo− are electrically connected to the ground end GND. The circuit topology diagram shown in FIG. 1 further comprises two three-switch bridge arms, a transformer assembly 4, a resonant capacitor Cr and an equivalent resonant inductor Llk, and further comprises at least one input capacitor Cin and at least one output capacitor Co. Each three-switch bridge arm comprises three switches electrically connected in series, the two three switch bridge arms are respectively a first switch bridge arm 11a and a second switch bridge arm 11b. The first switch bridge arm 11a comprises an upper switch Q1, a middle switch Q2 and a lower switch SR1; the upper switch Q1 and the middle switch Q2 are electrically connected to the upper node A1; the middle switch Q2 and the lower switch SR1 are electrically connected to the lower node B1. The second switch bridge arm 11b comprises an upper switch Q3, a middle switch Q4 and a lower switch SR2; the upper switch Q3 and the middle switch Q4 are electrically connected to the upper node A2; the middle switch Q4 and the lower switch SR2 are electrically connected to the lower node B2; the transformer assembly 4 comprises a high-voltage winding W1 (namely a third winding), a low-voltage winding W21 (namely a first winding) and a low-voltage winding W22 (namely a second winding). The high-voltage winding W1 is connected in series with a series resonance circuit composed of a resonant capacitor Cr and an equivalent resonant inductor Llk to form a series branch; and the series branch is bridged between the upper node A1 and the upper node A2. The first end of the high-voltage winding W1 is short-circuited with the equivalent resonant inductor Llk, and the second end of the high-voltage winding W1 is short-circuited with the resonant capacitor Cr. The second end of the low-voltage winding W21 and the second end of the low-voltage winding W22 are electrically connected to the output positive end Vo+, the first end of the low-voltage winding W21 is electrically connected to the lower node B1, and the first end of the low-voltage winding W22 is electrically connected to the lower node B2. The first end of the low-voltage winding W21 and the second end of the low-voltage winding W22 and the second end of the high-voltage winding are dotted terminals (namely being the same in polarity) and are marked as point ends, and the second end of the low-voltage winding W21 and the first end of the low-voltage winding W22 and the first end of the high-voltage winding are non-dotted terminals (namely being the same in polarity) and are marked as non-point ends. At least one output capacitor Co is bridged between the output positive end Vo+ and the grounding end GND; the equivalent resonant inductor Llk can be a parasitic leakage inductance of the magnetic component, and can be an external inductor or a combination of a parasitic leakage inductance of a magnetic component and an external inductor.

One end of at least one input capacitor Cin is electrically connected to the input positive end Vin+, and the other end is electrically connected to the output positive end Vo+, so that one part of the output current ripple generated by the two low-voltage windings flows into the output capacitor Co, the other part flows into the input capacitor Cin, and supplies the two three-switch bridge arms through the input capacitor Cin, so that the ripple current flowing into the output capacitor Co can be reduced, the capacitance of the output capacitor Co or the number of output capacitors Co can be reduced, and the purpose of further reducing the size of the power supply module is achieved. In other embodiments, the input capacitor Cin may also be bridged between the input positive end Vin+ and the ground end GND.

In the power conversion circuit 1a shown in FIG. 1, the upper switch Q1, the middle switch Q4 and the lower switch SR1 are synchronously turned on and turned off, and the upper switch Q3, the middle switch Q2 and the lower switch SR2 are synchronously turned on and turned off. In detail, the turn-on duty ratio of the upper switch Q1 and the upper switch Q3 is close to 50%; and the turn-on interval of the upper switch Q1 and the turn-on interval of the upper switch Q3 are staggered by 180 degrees.

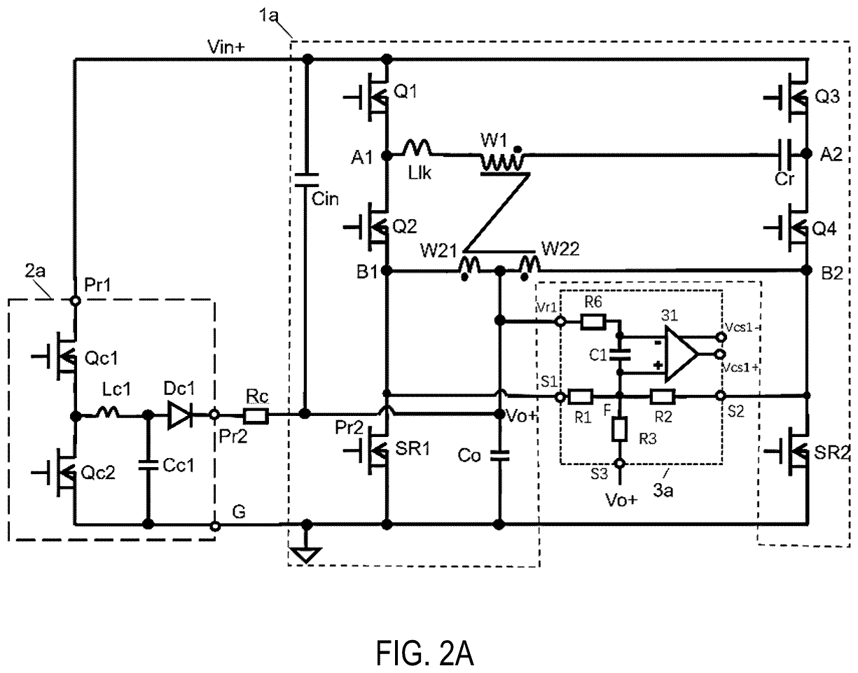

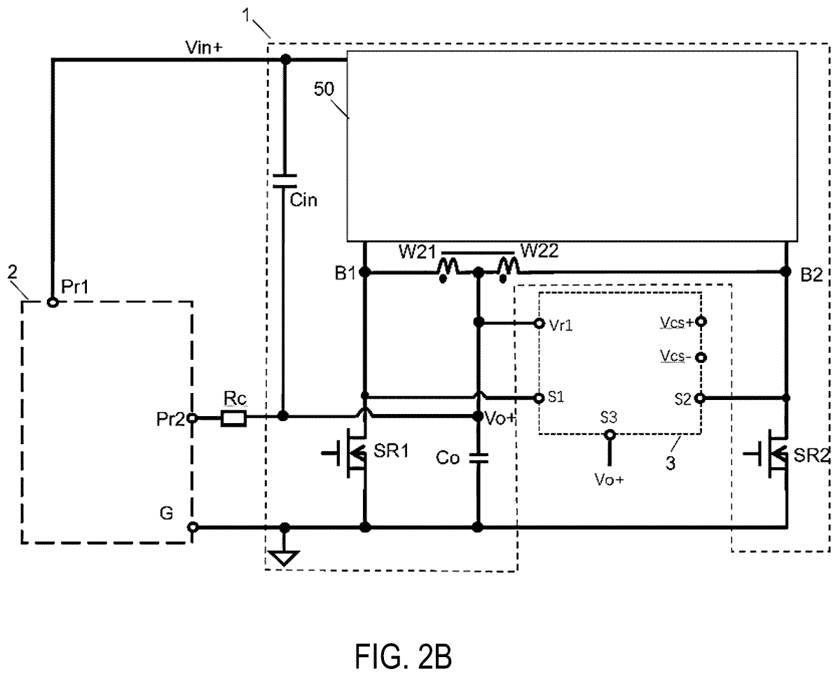

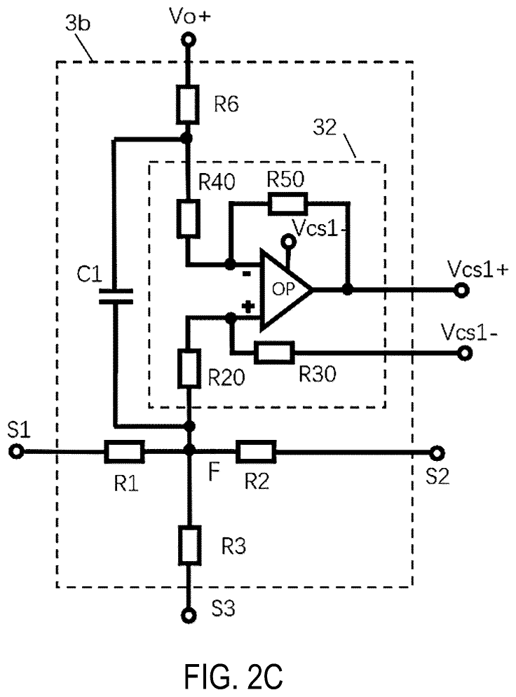

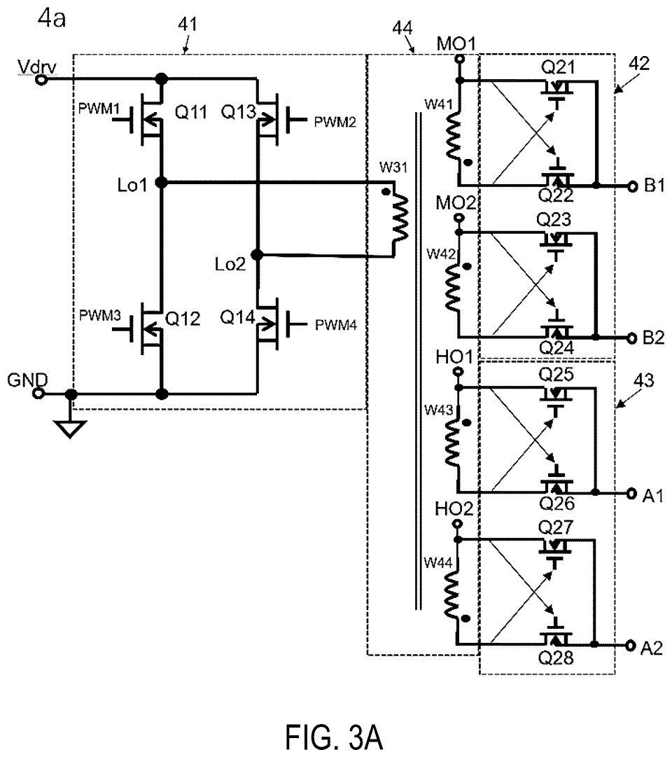

The application discloses a power conversion device as shown in FIG. 2A. The power conversion device comprises a power conversion circuit 1a, a pre-charging unit 2a, a current sampling unit 3a and at least one sampling resistor Rc as shown in FIG. 1. The pre-charging unit 2a comprises three ends, namely a switch end Pr1, an inductor end Pr2 and a grounding end G, wherein the grounding end G is electrically connected with the grounding end GND of the power conversion circuit 1a, the switch end Pr1 is electrically connected with the input positive end Vin+, the inductor end Pr2 is electrically connected with one end of the sampling resistor Rc, and the other end of the sampling resistor Rc is electrically connected with the output positive end Vo+ of the power conversion circuit 1a. The pre-charging unit 2a is used for pre-charging the output capacitor Co in the power conversion circuit 1a, so that before the power conversion circuit 1a is started-up, the energy of the input terminal Vin is converted through the pre-charging unit and used for pre-charging the voltage at the two ends of the output capacitor Co to a predetermined voltage, wherein the predetermined voltage is specifically any voltage greater than 70% of the output steady-state voltage Vo_normal of the power conversion circuit 1a to the output steady-state voltage Vo_normal. When the power conversion circuit 1a is started-up, the voltage at the two ends of the output capacitor Co is close to the output steady-state voltage Vo_normal, so that the impact current generated by the high voltage difference at the two ends of the series circuit flowing through the two switch bridge arms can be avoided, wherein the series circuit comprises the resonant capacitor Cr and the equivalent resonant inductor Llk; and meanwhile, the withstand voltage requirement of the two upper switches Q1 and Q2 is reduced.

As shown in FIG. 2A, the pre-charging unit 2a comprises two pre-charging switches Qc1 and Qc2, a pre-charging inductor Lc1, a pre-charging capacitor Cc1 and a pre-charging diode Dc1, wherein the drain electrode of the pre-charging switch Qc1 is electrically connected with the switch end Pr1, the source electrode of the pre-charging switch Qc1 is electrically connected with the drain electrode of the pre-charging switch Qc2, and the source electrode of the Qc2 is electrically connected with the grounding end G. A first end of the pre-charging inductor Lc1 is electrically connected to a source electrode of the pre-charging switch Qc1, the other end of the pre-charging inductor Lc1 is electrically connected with the positive electrode of the pre-charging diode Dc1 and the positive end of the pre-charging capacitor Cc1, the negative end of the pre-charging capacitor Cc1 is electrically connected with the grounding end G, and the negative electrode of the pre-charging diode Dc1 is electrically connected with the inductor end Pr2. The pre-charging unit 2a disclosed in the present embodiment is simple to implement and small in size; The implementation mode of the pre-charging unit is not limited to the circuit topology shown in FIG. 2A, as long as the function can be realized.

The application further discloses a current sampling unit combination schematic diagram and a power conversion device applying the current sampling unit combination. As shown in FIG. 2A and FIG. 2B, the current sampling unit combination comprises a current sampling resistor Rc and a current sampling unit 3, wherein the current sampling resistor Rc is electrically connected between the inductor end Pr2 of the pre-charging unit 2 and the output positive end Vo+ of the power conversion circuit 1a in series; the input end of the current sampling resistor Rc is short-circuited with the inductor end Pr2 of the pre-charging unit 2, and the output end of the current sampling resistor Rc is short-circuited with the output positive end Vo+ of the power conversion circuit 1a. In the pre-charging process, the charging current flows from the pre-charging unit 2 to the output capacitor Co and flows through the sampling resistor Rc. The drop voltage Vcs_Pr at the two ends of the sampling resistor Rc reflects the magnitude of the pre-charging current.

The current sampling unit 3 comprises three sampling ends S1/S2/S3, one reference voltage end Vr1, one sampling output positive end Vcs1+ and one sampling output negative end Vcs1−, and the sampling end S1 and the sampling end S2 are electrically connected with the first ends of the corresponding low-voltage windings respectively; and the sampling end S3 is electrically connected to one end (namely Vo+) of the current sampling resistor Rc. The reference voltage end Vr1 is electrically connected with the output positive end Vo+, and the voltage between the sampling output positive end Vcs1+ and the sampling output negative end Vcs1− is the sampling output voltage Vcs1.

Before the power conversion circuit 1a is started-up, the pre-charging unit charges the output capacitor Co, and the current flowing through the sampling resistor Rc is the pre-charging current; meanwhile, the voltage drop across the low-voltage winding W21 and the low-voltage winding W22 is zero, and the sampling output voltage Vcs of the current sampling unit combination only reflects the magnitude of the pre-charging working current. After the power conversion circuit 1a is started-up, the pre-charging unit 2 stops working, the voltage drop at the two ends of the sampling resistor Rc is zero, and at the moment, the sampling output voltage Vcs of the current sampling unit 2 reflects the sum working current of the low-voltage windings W21 and W22. According to the principle, the sampling output voltage Vcs of the current sampling unit combination can not only reflect the working current of the power conversion circuit 1a, but also can reflect the pre-charging current of the pre-charging unit 2a to the output capacitor Co before starting of the power conversion circuit 1a. When the sampling output voltage Vcs is used as an input signal of the detection and protection circuit, the abnormal working current of the power conversion circuit 1a can be detected and overcurrent protection, and the abnormal detection and overcurrent protection effects of the pre-charging current in the charging process of the output capacitor Co can be achieved. Therefore, comprehensive current detection and overcurrent protection effects in the operation process of the power conversion device are achieved.

As shown in FIG. 2A, the current sampling unit 3a disclosed in the embodiment comprises three sampling resistors R1, R2 and R3, one impedance matching resistor R6, one sampling capacitor C1 and an amplifying unit 31. One end of the sampling resistor R1, one end of the sampling resistor R2 and one end of the sampling resistor R3 are electrically connected to the sampling resistor midpoint F, and the other ends of the sampling resistors R1, R2 and R3 are electrically connected with the sampling end S1, the sampling end S2 and the sampling end S3 respectively. One end of the sampling capacitor C1 is connected with the midpoint F of the sampling resistor, and the other end of the sampling capacitor C1 is connected to the reference end Vr1 through the impedance matching resistor R6; and two ends of the sampling capacitor C1 are two sampling output ends. The amplifying unit 31 comprises an amplification reference end, an amplification input positive end, an amplification input negative end and an amplification output end. The amplification reference end (ie, the sampling output negative end Vcs1−) is electrically connected to the output negative end Vo− of the power conversion circuit 1a; the amplification input positive end is electrically connected to one sampling output end, that is, the sampling resistor midpoint F, the amplification input negative end is electrically connected to the other sampling output end, a current sampling signal Vcs1 is output between the amplification output end and the amplification reference end of the amplifying unit 31, and the current sampling signal Vcs1 is directly proportional to the voltage at the two ends of the sampling capacitor C1.

In another embodiment, the power conversion device can adopt the current sampling unit 3b as shown in FIG. 2C, and the amplifying unit 32 of the current sampling unit 3b is the specific implementation circuit of the amplifying unit 31 of the current sampling unit 3a. In the embodiment shown in FIG. 2C, the amplifying unit 32 comprises an operational amplifier OP, a second resistor R20, a third resistor R30, a fourth resistor R40 and a fifth resistor R50. The second resistor R20 is bridged between the positive input end of the operational amplifier OP and one end of the sampling capacitor C1, namely the sampling resistor midpoint F. The third resistor R30 is bridged between the positive input end of the operational amplifier OP and the reference end of the operational amplifier OP, that is, the output negative end Vo−. The fourth resistor R40 is bridged between the other end of the sampling capacitor C1 and the input negative end of the operational amplifier OP. The fifth resistor R50 is bridged between the output end of the operational amplifier OP and the input negative end, and the resistor meets the formula R30/(R20+(R1//R2//R3))=R50/(R40+R6), wherein R1//R2//R3 represents a parallel resistance value of a sampling resistor R1, a sampling resistor R2 and a sampling resistor R3, and wherein R20 is the resistance value of the second resistor, R30 is the resistance value of the third resistor, R40 is the resistance value of the fourth resistor, R50 is the resistance value of the fifth resistor, and R6 is the resistance value of the impedance matching resistor R6=R1//R2//R3. In the embodiment, the operational amplifier reference end Vcs1− can be connected with the output negative end Vo− of the power conversion circuit 1a, and can also be connected with a reference potential. When the voltage at the two ends of the sampling capacitor C1 is zero, the voltage of the sampling output end Vcs1+ to the output negative end Vo− of the power conversion circuit 1a comprises one bias voltage, and the bias voltage is the reference potential.

The implementation circuit of the amplifying unit 32 is not limited to only as shown in FIG. 2A and FIG. 2C, as long as the current sampling signal Vcs1 output by the amplifying unit can be proportional to the voltage at the two ends of the sampling capacitor C1.

The current sampling scheme disclosed by the application is not limited to the power conversion circuit shown in FIG. 1. Refer to FIG. 2B, the current sampling scheme disclosed by the application can be applied to the power conversion circuit comprising two lower switches, two low-voltage windings, an output capacitor Co, a pre-charging unit 2, a current sampling resistor Rc bridged between the pre-charging unit 2 and the output capacitor Co and a circuit unit 50 are included. In FIG. 2B, the first end of the circuit unit 50 is electrically connected to the input positive end Vin+ of the power conversion circuit 1a, the second end and the third end of the circuit unit 50 are electrically connected to the lower node B1 and the lower node B2 of the power conversion circuit 1a respectively, the second end and the third end of the circuit unit 50 may also be electrically connected to the input positive end Vin+, or the second end and the third end of the circuit unit 50 may also be electrically connected to the output positive end Vo+ of the power conversion circuit 1a; or the second end of the circuit unit 50 is electrically connected to one of the lower node B1 and the lower node B2, and the third end of the circuit unit 50 is electrically connected to one of the output positive end Vo+ or the output negative end Vo− of the power conversion circuit 1a.

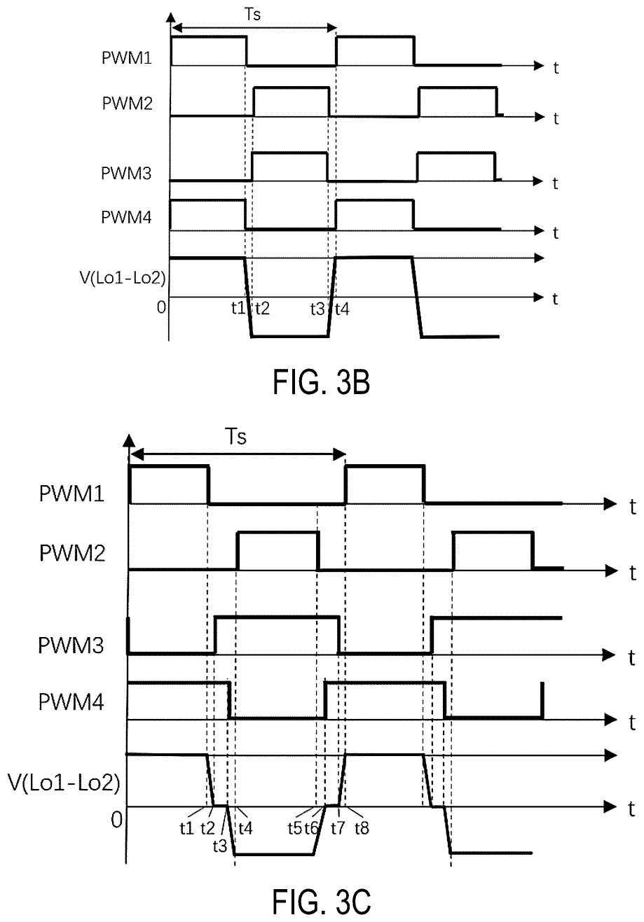

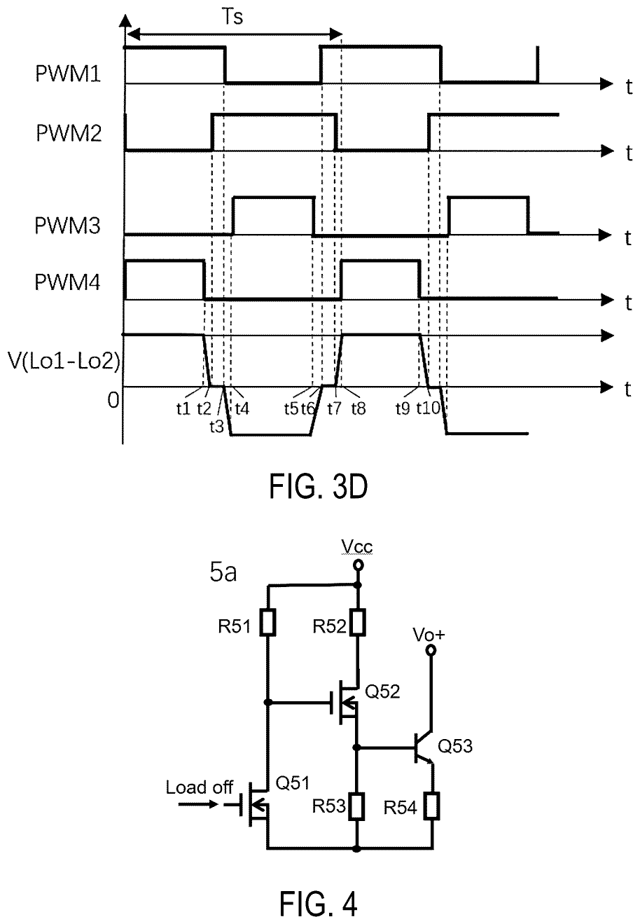

The power conversion device further comprises a driving unit 4a, which provides a driving signal for the upper switch Q1/Q3, the middle switch Q2/Q4 and the lower switch SR1/SR2 as shown in FIG. 1. As shown in FIG. 3A, the driving unit 4a comprises a lower switch driving unit 41, a middle switch driving unit 42, an upper switch driving unit 43 and a driving magnetic piece 44. The lower switch driving unit 41 comprises a driving power supply positive end Vdrv, a grounding end GND, a lower switch driving output end Lo1/Lo2 and four control switches Q11/Q12/Q13/Q14, wherein the source electrode of the control switch Q11 and the drain electrode of Q12 are connected in series to the lower switch driving output end Lo1, the drain electrode of the control switch Q11 is electrically connected to the driving power supply positive end Vdrv, and the source electrode of the control switch Q12 is electrically connected to the grounding end GND. The source electrode of the control switch Q13 and the drain electrode of Q14 are connected in series to the lower switch drive output end Lo2, the drain electrode of the control switch Q13 is electrically connected with the positive terminal Vdrv of the driving power supply, the source electrode of the control switch Q14 is electrically connected with the ground terminal GND, that is, the four control switches are electrically connected and form a full-bridge structure. The full-bridge is bridged between the positive end of the driving power supply and the grounding end. and the driving output end of the first lower switch and the driving output end of the second lower switch are respectively the midpoint of the two bridge arms. With reference to FIGS. 3B to 3D, control signal comprises a first control signal PWM1, a second control signal PWM2, a third control signal PWM3 and a fourth control signal PWM4. The first control signal PWM1 is used for controlling the on and off of the switch Q11, the second control signal PWM2 is used for controlling the on and off of the switch Q13, the third control signal PWM3 is used for controlling the on and off of the switch Q12, and the fourth control signal PWM4 is used for controlling the on and off of the switch Q14. The voltage of the lower switch driving output Lo1 is used for driving the lower switch SR1, and the voltage of the lower switch driving output Lo2 is used for driving the lower switch SR2. The driving magnetic piece 44 comprises a driving winding W31, a first middle winding W41, a second middle winding W42, a first upper winding W43 and a second upper winding W44. The driving winding W31, the first middle winding W41, the second middle winding W42, the first upper winding W43 and the second upper winding W44 are wound on the same transformer magnetic core. The first end of the driving winding W31, the second end of the first middle winding W41, the first end of the second middle winding W42, the first end of the first upper winding W43 and the second end of the second upper winding W44 are dotted terminals, and are marked as point ends. The first end of the driving winding W31 is electrically connected with the lower switch driving output Lo1, and the second end of the W31 is electrically connected with the lower switch driving output Lo2.

The middle switch driving unit 42 comprises a middle driving switch Q21, Q22, Q23 and Q24, wherein a drain electrode of the driving switch Q21 is electrically connected to a first end of the first middle winding W41, and is electrically connected to a gate electrode of a middle switch Q2 of the power conversion circuit 1a (namely a middle switch driving output Mo1), the drain of the middle driving switch Q22 is electrically connected to the second end of the first middle winding W41. The source of the middle drive switch Q21 and Q22 is electrically connected to the lower node B1 of the power conversion circuit 1a. The voltage between the first end of the first middle winding W41 and the lower node B1 is used for controlling the turn-on and turn-off of the middle drive switch Q22, so that when the voltage from the first end to the second end of the first middle winding W41 is a positive voltage, the middle driving switch Q22 is turned on, and the voltage from the middle switch driving output Mo1 to the lower node B1 is a positive voltage and approximately equal to the voltage at the two ends of the first middle winding W41. The voltage between the second end of the first middle winding W41 and the lower node B1 is used for controlling the turn-on and turn-off of the middle driving switch Q21, so that when the voltage drop from the second end to the first end of the first middle winding W41 is a positive voltage, the middle driving switch Q21 is turned-on, and the voltage of the middle switch drive output Mo1 to the lower node B1 is zero. The drain electrode of the middle driving switch Q23 is electrically connected to a first end of the second middle winding W42, and is electrically connected to the gate of a middle switch Q4 (ie, a medium switch driving output Mo2), the drain electrode of the middle driving switch Q24 is electrically connected to the second end of the first middle winding W42, the source electrodes of the middle drive switches Q23 and Q24 are electrically connected in parallel to the lower node B2 of the power conversion circuit 1a. The voltage between the first end of the first middle winding W42 and the lower node B2 is used for controlling the turn-on and turn-off of the middle drive switch Q24, so that when the voltage of the first end to the second end of the first middle winding is a positive voltage, the middle drive switch Q24 is turned on, and the voltage of the middle switch drive output Mo2 to the lower node B2 is a positive voltage and approximately equal to the voltage at the two ends of the first middle winding W42. The voltage between the second end of the second middle winding W42 and the lower node B2 is used for controlling the turn-on and turn-off of the middle drive switch Q23, so that when the voltage of the second end to the first end of the second middle winding W42 is a positive voltage, the middle drive switch Q23 is turned on, and the voltage of the middle switch drive output Mo2 to the lower node B2 is zero.

The upper switch driving unit 43 comprises upper driving switches Q25, Q26, Q27 and Q28, wherein a drain electrode of the driving switch Q25 is electrically connected to a first end of the first upper winding W43 and is electrically connected to a gate electrode of the upper switch Q1 of the power conversion circuit 1a (ie, the upper switch drive output Ho1). The drain electrode of the upper driving switch Q26 is electrically connected to the second end of the first upper winding W43, and the source electrodes of the upper driving switch Q25 and Q26 are electrically connected to the upper node A1 of the power conversion circuit 1a. The voltage between the first end of the first upper winding W43 and the upper node A1 is used for controlling the on and off of the upper driving switch Q26, so that when the voltage of the first end to the second end of the first upper winding W43 is a positive voltage, the upper driving switch Q26 is turned on, and the voltage of the upper switch driving output Ho1 to the upper node A1 is a positive voltage and approximately equal to the voltage at the two ends of the first upper winding W43. The voltage between the second end of the first upper winding W43 and the upper node A1 is used for controlling the on and off of the upper driving switch Q25, so that when the voltage of the second end to the first end of the first upper winding W43 is positive voltage, the upper driving switch Q25 is switched on, and the voltage of the upper switch driving output Ho1 to the upper node A1 is zero. The drain electrode of the upper driving switch Q27 is electrically connected to the first end of the second upper winding W44 and is electrically connected to the gate electrode of the upper switch Q3 of the power conversion circuit 1a (ie, an upper switch drive output Ho2), the drain electrode of the upper drive switch Q28 is electrically connected to the second end of the second upper winding W44. The source electrodes of the upper driving switches Q27 and Q28 are electrically connected in parallel to the upper node A2 of the power conversion circuit 1a. The voltage between the first end of the second upper winding W44 and the upper node A2 is used for controlling the on and off of the upper driving switch Q28, so that when the voltage of the first end to the second end of the second upper winding W44 is a positive voltage, the upper driving switch Q28 is switched on, and the voltage of the upper switch driving output Ho2 to the upper node A2 is a positive voltage and is approximately equal to the voltage at the two ends of the second upper winding W44. The voltage between the second end of the second upper winding W44 and the upper node A2 is used for controlling the turn-on and turn-off of the upper driving switch Q27, so that when the voltage of the second end to the first end of the second upper winding W43 is a positive voltage, the upper driving switch Q27 is turned on, and the voltage of the upper switch driving output Ho2 to the upper node A2 is a zero.

Detailed control signals are shown in FIG. 3B, FIG. 3C and FIG. 3D. As shown in FIG. 3B, the duty ratio of the first control signal PWM1 and the second control signal PWM2 is a fixed duty ratio, and the duty ratio is any value within the range of 40%≤D<50%. The first control signal PWM1 and the second control signal PWM2 are staggered by 180 degrees, and the control switches Q11 and Q13 are respectively controlled by PWM1 and PWM2. The third control signal PWM3 is the same as the second control signal PWM2 and is used for controlling the control switch Q12; and the fourth control signal PWM4 is the same as the first control signal PWM1 and is used for controlling the control switch Q14. A switching period Ts is from a moment 0 to a moment T4, wherein the intervals t1-t2 and the intervals t3-t4 are dead time. In the interval 0-t1, the first control signal PWM1 and the fourth control signal PWM4 are high levels and respectively correspond to the control switches Q11 and Q14 to be conducted; and the second control signal PWM2 and the third control signal PWM3 are low levels and respectively correspond to the control switches Q13 and Q12 to be cut off; so that the voltage drop V(Lo1-Lo2) at the two ends of the driving winding W31 is a positive voltage. In the intervals t2-t3, the second control signal PWM2 and the third control signal PWM3 are high levels and respectively correspond to the control switches Q13 and Q12 to be conducted; the first control signal PWM1 and the fourth control signal PWM4 are low levels and respectively correspond to the control switches Q11 and Q14 to be cut off; so that the voltage drop V(Lo1-Lo2) at the two ends of the driving winding W31 is a negative voltage. In the dead zones t1-t2, the magnetizing current of the driving winding W31 extracts the charges of the equivalent junction capacitors Cds at the two ends of the control switch Q12, and charges the equivalent junction capacitors Cds at the two ends of the control switch Q14, so that V(Lo1-Lo2) firstly descends from Vdrv to zero, further from zero to −Vdrv. In the dead zone t3-t4, the magnetizing current of the driving winding W31 charges the equivalent junction capacitor Cds at the two ends of the control switch Q12, and charges of the equivalent junction capacitor Cds at the two ends of the control switch Q14 are extracted, so that V(Lo1-Lo2) firstly rises from −Vdrv to zero, and further rises from zero to +Vdrv. The driving control mode shown in FIG. 3B enables the voltage drop V(Lo1-Lo2) at the two ends of the driving winding W31 to have only positive voltage and negative voltage. In order to ensure the necessary dead time between the switches in the power conversion circuit 1a, the switches of the power conversion circuit 1a can realize the soft switch, so that the magnetization current of the drive winding cannot be too large, and the speed of the magnetization current for extracting the gate electrode charge of the switch cannot be too fast. The side effect of the method can make the turn-off speed of the switch of the power conversion circuit 1a too slow, so that the turn-off loss of the switch is too high.

In another embodiment, as shown in FIG. 3C, the duty ratio of the first control signal PWM1 and the second control signal PWM2 is a fixed duty ratio, and the duty ratio is any value within the range of 40%≤D<50%. The first control signal PWM1 and the second control signal PWM2 are staggered by 180 degrees, and control switches Q11 and Q13 are respectively controlled. The third control signal PWM3 and the first control signal PWM1 approximately meet a complementary relationship and are used for controlling the control switch Q12. The fourth control signal PWM4 and the second control signal PWM2 approximately meet a complementary relationship and are used for controlling the control switch Q14. A switching perod Ts is from the moment 0 to t8 of the control switch Q14, the intervals t1-t4 and the intervals t5-t8 are dead time, the intervals t1-t4 are taken as examples to describe the features of the dead zone, and the intervals t5-t8 are similar. In the interval t1-t2, the magnetizing current of the driving winding W31 extracts the charges of the equivalent junction capacitors Cds at the two ends of the control switch Q12, so that V(Lo1-Lo2) firstly descends from Vdrv to zero. In the interval t2-t3, since the two control switches Q12 and Q14 are in a conducting state, the voltages V(Lo1-Lo2) at the two ends of the driving winding W31 are zero. In the intervals t3-t4, the magnetizing current of the driving winding W31 charges the equivalent junction capacitors Cds at the two ends of the control switch Q14, so that V(Lo1-Lo2) drops from zero to −Vdrv. In the embodiment, the voltage V(Lo1-Lo2) at the two ends of the driving winding W31 can be positive voltage, zero voltage and negative voltage. Here, the interval of zero voltage (ie, interval t2-t3 and interval t6-t7) in V(Lo1-Lo2) is the high potential overlapping area of the third control signal PWM3 and the fourth control signal PWM4, and the driving winding W31 carries out freewheeling through the two control switches Q12 and Q14. The existence of the zero voltage interval in V(Lo1-Lo2) can enable that the dead time doesn't affect the turn-off speed of the switch in the power conversion circuit 1a. The turn-off time of the switch can be reduced, the turn-off loss of the switch is reduced, the dead time required by each power switch in the power conversion circuit 1a to realize the soft switch can be ensured, and the conversion efficiency of the power conversion device is improved.

In another embodiment, as shown in FIG. 3D, the duty ratio of the first control signal PWM1 to the second control signal PWM2 is a fixed duty ratio, and the duty ratio is any value within a range of 50%<D≤60%. A switching period is from the moment 0 to t8. The intervals t1-t4 and the intervals t5-t8 are dead time. In this embodiment, the features between the two dead time intervals in one switching period are the same as those shown in FIG. 3C, and details are not described herein again. The difference lies in that the interval of the zero voltage of the terminal voltage V(Lo1-Lo2) in the embodiment is the high potential overlapping area of the first control signal PWM1 and the second control signal PWM2, and the driving winding W31 performs freewheeling through the two control switches Q11 and Q13.

According to the power conversion device disclosed by the application, the input capacitor Cin and the output capacitor Co are electrically connected in series. When the input voltage Vin rises, even when the power conversion device does not enter the working mode, the output voltage Vo can also have residual voltage with the rising of the input voltage. At this time, a dummy load unit 5a needs to be added at the output end of the power conversion device. When the power conversion device does not enter the working state, the dummy load unit 5a is switched into, so that the dummy load unit 5a is bridged between the output positive end Vo+ and the output negative end Vo− (ie, the grounding end GND) of the power conversion device and is used for consuming the residual voltage of the output end. When the power conversion device enters the working state, the dummy load unit 5a is cut out, so that the loss of the power conversion device is not increased.

As shown in FIG. 4, the dummy load unit 5a disclosed in the present application comprises a dummy load control switch Q51, a dummy load control switch Q52, a dummy load amplifying switch Q53 and current limiting resistors R51 to R54, wherein the drain electrode of the dummy load control switch Q51 is connected in series with one end of the current limiting resistor R51, the source electrode of the dummy load control switch Q51 is electrically connected with the output negative end Vo−, the gate electrode of the dummy load control switch Q51 receives a dummy load control signal Load-off, and the other end of the current limiting resistor R51 is electrically connected with the power supply voltage Vcc (Vcc can be 5V or 3.3 V). The gate electrode of the dummy load control switch Q52 is electrically connected to the drain electrode of the dummy load control switch Q51, the drain electrode of the dummy load control switch Q52 is electrically connected with one end of the current limiting resistor R52, the other end of the current limiting resistor R52 is electrically connected with the power supply voltage Vcc, the source electrode of the dummy load control switch Q52 is electrically connected with one end of the current limiting resistor R53, and the other end of the current limiting resistor R53 is electrically connected with the output negative end Vo−. The base electrode of the dummy load amplifying switch Q53 is electrically connected to the source of the dummy load control switch Q52, the collector of the dummy load amplifying switch Q53 is electrically connected to the output positive end Vo+ of the power conversion circuit 1a, the emitter of the dummy load amplifying switch Q53 is electrically connected to one end of the current limiting resistor R54, and the other end of the current limiting resistor R54 is electrically connected to the output negative end Vo−.

When the dummy load control signal Load-off is at a high level (5V or 3.3 V), it is indicated that the power conversion device is about to start to work, and at the moment, the dummy load unit 5a needs to be cut out from the output of the power conversion device, so that the amplification switch Q53 is cut off. When the dummy load control signal Load-off is at a low level, the dummy load unit 5a needs to be switched into the output of the power conversion device, specifically, the dummy load control switch Q51 is turned off, and meanwhile, the dummy load control switch Q52 is turned on, so that the current Ice (the collector and the emitter) flowing through the dummy load amplifying switch Q53 is N times of the current Ibe (the base and the emitter), and the magnitude of the current Ice can be set by the resistance values of the current-limiting resistors R52, R53 and R54, so that the amplifying switch Q53 is in an amplified or conducting state.

In practical application, the dummy load control signal Load-off is jointly determined by the start signal and the output voltage Vo of the power conversion device. When the start signal of the power conversion device is at a high level, the power conversion circuit 1a will start to work, and the dummy load control signal Load-off needs to be set to a high level, so that the dummy load unit 5a is cut out from the output of the power conversion device. When the starting signal of the power conversion device is at a low level, the magnitude of the output voltage Vo needs to be judged at the same time; and when the output voltage Vo is smaller than a preset voltage Vref, the dummy load control signal Load-off needs to be set to be low, so that the dummy load unit 5a is cut into the output of the power conversion device and discharges the output voltage. When the start signal of the power conversion device is at a low level and the output voltage Vo is greater than or equal to a preset voltage Vref, the dummy load control signal Load-off needs to be set to a high level, so that the dummy load unit 5a is cut out from the output of the power conversion device. In the case that the power conversion device comprises two or more power conversion circuits connected in parallel. The parallel application of the two power conversion circuits 1a and 1b is taken as an example for description. When the control signal Load-off of the dummy load corresponding to the control power conversion circuit 1a is at a low level, the magnitude of the output voltage Vo needs to be judgedat the same time, and when the output voltage Vo is greater than or equal to the preset voltage Vref, it is indicated that the power conversion circuit 1b is in a normal working state, the dummy load unit 5a needs to be cut out from the power conversion device.

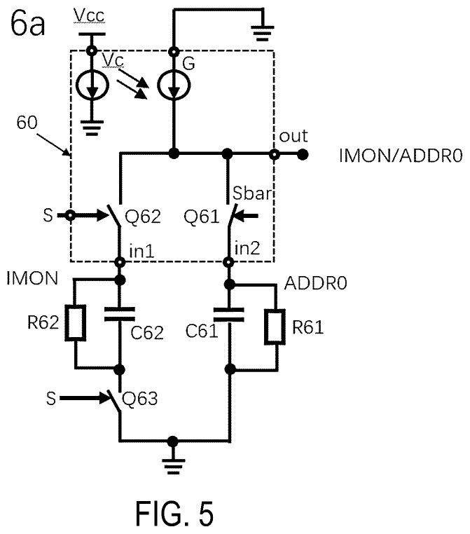

As the function of the power conversion device is increased, the pins of the controller or the microprocessor are not enough, and the current sharing bus function of the power conversion device and the address function of the power management bus (PMBUS) are time-division multiplexing of one pin of the controller or the microprocessor (MCU). The time-division multiplexing pin needs to have the current source output capability and the A/D conversion function capability of the pin voltage at the same time. In the embodiment, the address function of the power management bus (PMBUS) is electrically initialized on the microprocessor MCU to complete the site selection function, and the current sharing bus function starts to work after the power conversion device receives the starting signal of the output voltage; therefore, the time-division multiplexing method is adopted, the small-size microprocessor MCU with limited pin quantity can be adopted, and the complex function requirement of the power conversion device can be met. In detail, as shown in the gating circuit 6a shown in FIG. 5, the gating circuit 6a comprises a gating switch 60, wherein the gating switch 60 comprises a power supply end Vc, a grounding end G, a control end S, an input end in1 and in2 and an output end OUT∘The input end in1 and in2 are electrically connected with the address function ADDR0 pin of the power management bus (PMBUS) and the current sharing bus IMON pin of the power conversion device respectively, and the output end OUT is connected with the IMON/ADDR0 pin of the microprocessor MCU. When the voltage of the control end S is at a low level (ie, before the power conversion device is started), the current sharing switch Q62 is turned off and the address switch Q61 is turned on, the current source of the gating switch 60 generates a voltage signal ADDR0 on the input end in2, and the voltage signal is communicated with the output end OUT, that is, the voltage of the output end OUT represents the address function ADDR0 signal of the power management bus (PMBUS). Here, the control end S voltage may be a start control signal of the power conversion device. When the voltage of the control end S is at a high level (ie, after the power conversion device is started), the current sharing switch Q62 is turned on and the address switch Q61 is turned off, a current source of the gating switch 60 generates a voltage signal IMON on the input end in1, and the voltage signal is communicated with the output end OUT, that is, the voltage of the output end OUT represents the IMON signal of the current sharing bus. The input end in2 is electrically connected with the address circuit unit (comprising an address capacitor and an address resistor), that is, the input end in2 is externally connected with an address capacitor C61 and an address resistor R61 which are connected in parallel. The input end in1 is electrically connected with the current sharing circuit unit (comprising a current sharing resistor, a current sharing capacitor and a current sharing switch), that is, the input end in1 is externally connected with a current sharing capacitor C62 and a current sharing resistor R62 which are connected in parallel and a ground switch Q63, one end of the ground switch Q63 is electrically connected with the current sharing capacitor C62 and the current sharing resistor R62, and the other end of the ground switch Q63 is grounded. When a plurality of power conversion devices are connected in parallel, the input ends in1 of the plurality of gating circuits 60 are also connected in parallel to form a current sharing bus of the plurality of power conversion devices, the working current amplitude information of the plurality of power conversion devices is reflected, and the current sharing bus can be used for the current sharing function or the current information reporting function of the plurality of power conversion devices. When only a part of the power conversion devices in the plurality of power conversion devices are in a normal working state, the current sharing resistor R62 of the power conversion device in a non-working state need to be disconnected with the input end in1, so that the current sharing resistor R62 of the power conversion device in a non-working state influences the working voltage amplitude on the current sharing bus. The voltage of the control end S can be used for controlling the turn-on and turn-off of the ground switch Q63, and when the ground switch Q63 is turned off, the input end in1 is in a high-resistance state, that is, the current sharing resistor R62 is disconnected with the input end in1, and the working voltage amplitude on the current sharing bus of other working parallel power conversion devices is not affected.

In this embodiment, the gating circuit 60 may be implemented by an independent device, or may be implemented by a plurality of devices. For example, a current source may be located within the microprocessor MCU and connected to a pin of the IMON/ADDR0 of the microprocessor MCU. The present application is not limited thereto, as long as the technical features and technical effects disclosed in the present application are within the protection scope of the present application.

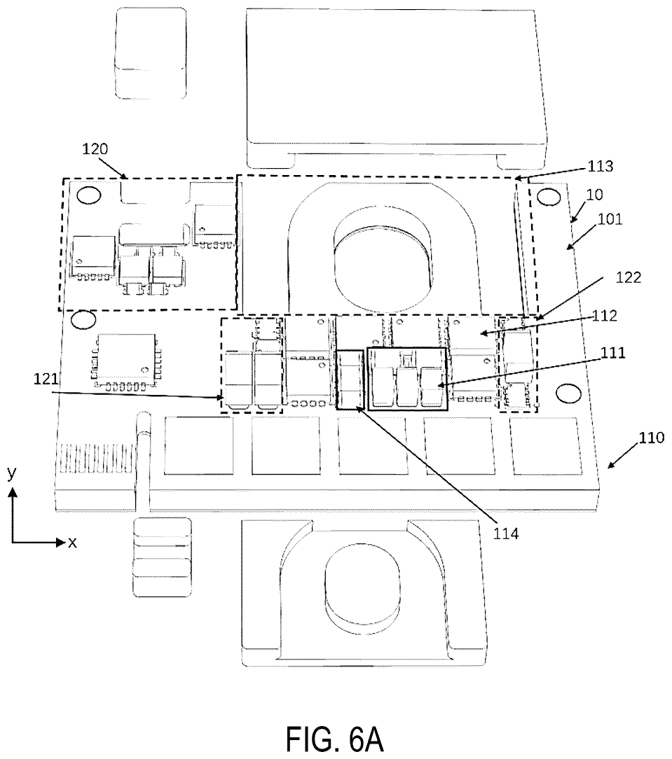

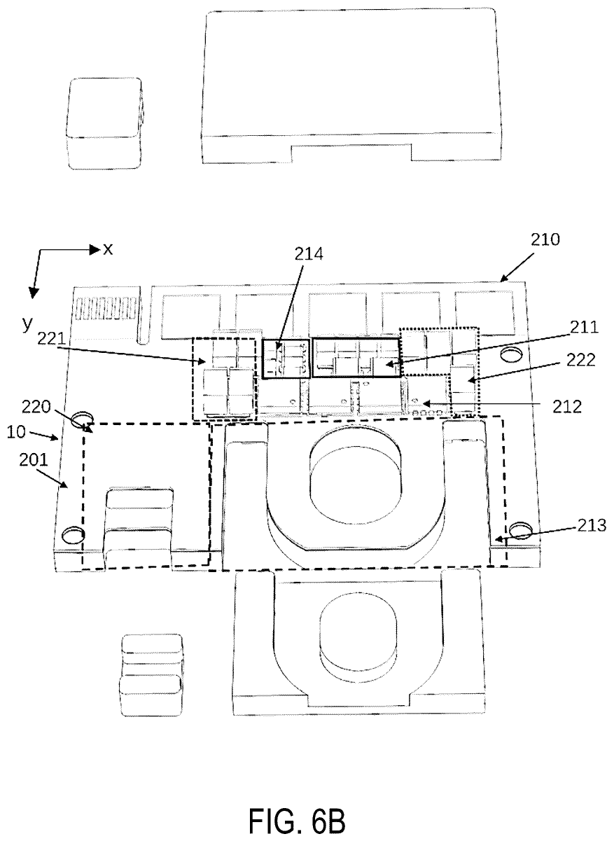

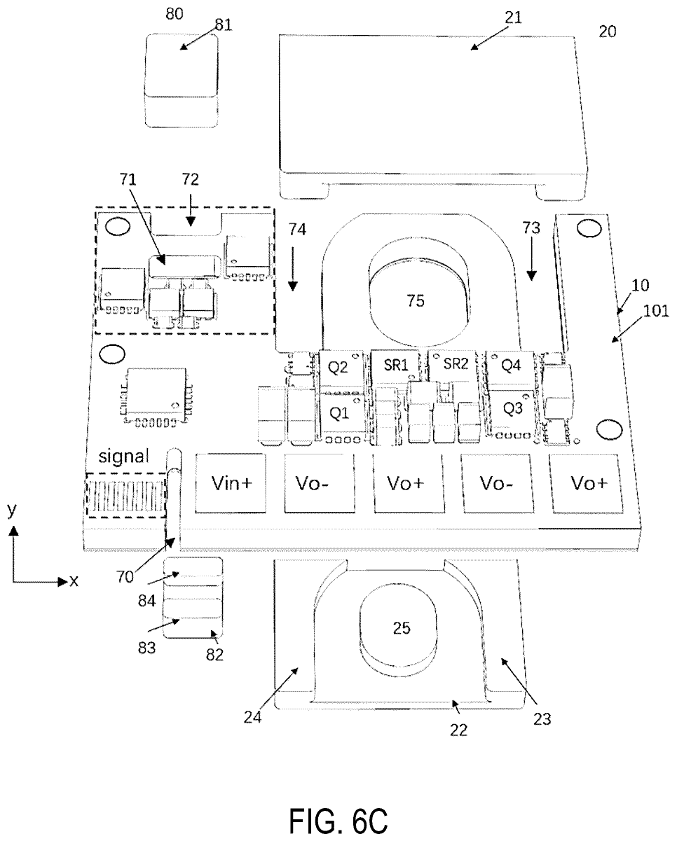

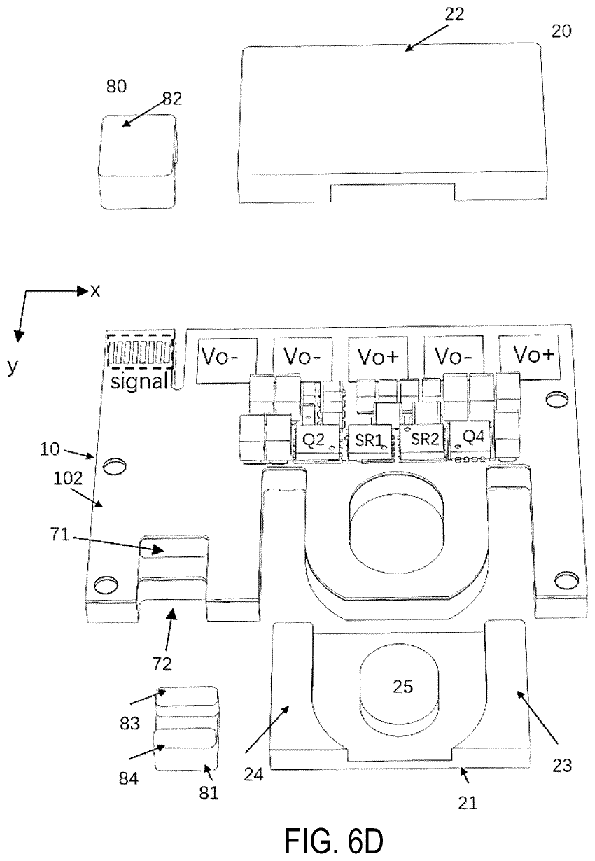

The structure layout of the power conversion device A of the application power conversion circuit 1 and the driving unit 4a shown in FIG. 3A, and the magnetic core explosion diagram are shown in FIGS. 6A-6D, wherein FIGS. 6A and 6C are top views, and FIG. 6B and FIG. 6D are bottom views. The power conversion device A comprises a circuit substrate 10, a transformer magnetic core 20, upper switches Q1 and Q3, middle switches Q2 and Q4, lower switches SR1 and SR2, a resonant capacitor Cr, an output capacitor Co, an input capacitor Cin, a driving unit 4a, an input positive end Vin+, an output negative end Vo+, an output negative end Vo− (namely a grounding end GND) and a signal end Signal.

As shown in FIG. 6A to FIG. 6D, the circuit substrate 10 comprises a first surface 101 and a second surface 102 opposite to each other, and further comprises hole grooves 73 and 74 and holes 75. The hole grooves 73 and 74 and the holes 75 penetrate through the first surface 101 and the second surface 102. The periphery of the hole 75 is surrounded by the circuit substrate 10, at least one side of the hole grooves 73 and 74 is open, and the remaining side surfaces are surrounded by the circuit substrate. The occupation of the surface area of the circuit substrate 10 can be reduced as much as possible by the design of the hole groove, and the size of the power conversion device is reduced. In another embodiment, the holes 73 and 74 may also be designed as holes as well as holes 75 around the circuit substrate 10. FIG. 6A shows a layout of a first surface 101 of a circuit substrate 10, and FIG. 6B shows a layout of a second surface 102 of the circuit substrate 10. The first surface 101 of the circuit substrate 10 comprises a port area 110, an output capacitor area 111, a switch area 112, a transformer magnetic core area 113, a resonant capacitor area 114, a lower switch driving area 120, an middle-upper switch driving area 121 and a 122. An input positive end Vin+, an output negative end Vo+, an output negative end Vo− (namely a grounding end GND) and a signal end Signal are arranged in the port area 110; and the port area 110 is realized by adopting a plating golden finger on the PCB on one side of the first surface 101 of the circuit substrate 10. The output capacitor Co is arranged in the output capacitor region 111; the upper switch Q1/Q3, the middle switch Q2/Q4 and the lower switch SR1/SR2 are arranged in the switch area 112; and a part of the transformer magnetic core 20 is arranged in the transformer magnetic core area 113; and the resonant capacitor Cr is arranged in the resonant capacitor region 114; a part of the device of the driving unit 4a as shown in FIG. 3A is arranged in the lower switch driving area 120 and the middle-upper switch driving area 121 and 122; the input capacitor Cin is arranged in the middle-upper switch driving area 121 and 122. The second surface 102 of the circuit substrate 10 comprises a port area 210, an output capacitor area 211, a switch area 212, a transformer magnetic core area 213, a resonant capacitor area 214, an middle-upper switch driving area 221 and 222. An input positive end Vin+, an output negative end Vo+, an output negative end Vo− (namely a grounding end GND) and a signal end Signal are arranged in the port area 210; the port area 210 is realized by adopting a plating golden finger on the PCB on one side of the second surface 102 of the circuit substrate 10; and the projection of the port area 210 and the projection of the port area 110 on the first surface 102 are all or partially overlapped. The output capacitor Co is arranged in the output capacitor region 211; the middle switch and the lower switch are arranged in the switch region 212; and a part of the transformer magnetic core of the transformer magnetic core 20 is arranged in the transformer magnetic core area 213; and the resonant capacitor Cr is arranged in the resonant capacitor region 214; a part of the device of the driving unit 4a shown in FIG. 3A is arranged in the lower switch driving area 220; and the input capacitor Cin is arranged in the middle-upper switch driving areas 221 and 222. In the embodiment, the transformer magnetic core area 113, the switch area 112, the output capacitor area 111 and the port area 110 are sequentially arranged in the same direction (as shown in FIG. 6A in the Y-axis direction); or the transformer magnetic core region 113, the switch region 112, the resonant capacitor region 114 and the port region 110 are sequentially arranged in the same direction (as shown in FIG. 6A in the Y-axis direction), referring to the power conversion circuit shown in FIG. 1, so that each end of the winding in the transformer assembly 4 is connected with the corresponding switch nearby, or the corresponding resonant capacitor is connected nearby, or the corresponding output capacitor Co is connected nearby. Furthermore, the two ends of the output capacitor and one or both ends of the winding in the transformer assembly 4 are connected to the output positive end Vo+ and the output negative end Vo− of the port area 110 nearby, so that the current path formed by any two of the winding, the switch (tube?), the resonant capacitor Cr, the output capacitor Co, the output positive end Vo+ and the output negative end Vo− in the transformer assembly 4 is the shortest, the parasitic impedance on the current path is reduced, and the conversion efficiency of the power conversion device is improved.

In detail, with reference to the detailed layout diagram on the first surface shown in FIG. 6C and the detailed layout diagram on the second surface shown in FIG. 6D, the input positive end Vin+, the output positive end Vo+, the output negative end Vo− and the signal end Signal are arranged in the port regions 110 and 210 in a golden finger manner. In FIG. 6C, the output negative end Vo−, the output positive end Vo+ are arranged in a staggered mode, the signal end Signal, the input positive end Vin+ and the output negative end Vo−, and the output positive end Vo+ are arranged in the X-axis direction from left to right. In FIG. 6D, a signal end Signal, the output negative end Vo−, the output negative end Vo− and the output positive end Vo+ are arranged in the X-axis direction from left to right, so that the power conversion device and the system mainboard (not shown) can be installed and fixedly connected through plugging and unplugging, and convenience and rapidness are achieved. The golden fingers corresponding to the signal end Signal are located in the port areas 110 and 210 on the first side of the substrate. Each of the output positive end Vo+ and the output negative end Vo− comprise at least two golden fingers, and the gold fingers corresponding to the output positive end Vo+ and the output negative end Vo− are located in the port regions 110 and 210 on the second side of and the substrate and close to the board edge; the second side is opposite to the first side position; the golden finger corresponding to the input positive end Vin+ is located in the port region 110, and is located between the golden finger corresponding to the signal end Signal and the golden finger corresponding to the output positive end Vo+ or the output negative end Vo−.

The transformer magnetic core 20 comprises two transformer magnetic substrates 21 and 22, transformer side columns 23 and 24 and a transformer middle column 25. The transformer side columns 23 and 24 and the transformer middle column 25 respectively penetrate through the corresponding hole grooves 73 and 74 and the holes 75, and are buckled with the two transformer magnetic substrates 21 and 22. On the circuit substrate 10, some or all of the circuit substrates between the hole groove 73 and the hole 75, and between the hole groove 74 and the hole 75 are used for arranging transformer windings W1, W21 and W22. Each end of the transformer windings W1, W21 and W22 is arranged adjacent to the switch areas 112 and 212, and the winding mode of the transformer winding is not limited. Correspondingly, the middle switches Q2/Q4 and the lower switches SR1/SR2 arranged in the switch areas 112 and 212 are arranged close to the transformer magnetic core area 113, and the middle switches Q2/Q4 and the lower switches SR1/SR2 are placed in the X-axis direction. Furthermore, the two lower switches SR1/SR2 are arranged between the two middle switches Q2/Q4. The projection of each middle switch Q2 on the first surface 101 partially coincides with or completely coincides with the projection of the corresponding middle switch Q4 arranged on the second surface 102 on the first surface. Similarly, the projection of each lower switch SR1 on the first surface 101 on the first surface coincides with or completely coincides with the projection of the corresponding lower switch SR2 arranged on the second surface 102 on the first surface. The upper switches Q1 and Q3 are arranged on the switch area 112 on the first surface 101 and are respectively adjacent to the middle switches Q2 and Q4 and are respectively adjacent to the resonant capacitor Cr and the output capacitor Co. The upper switch and the resonant capacitor Cr and the output capacitor Co are placed in the X-axis direction, and the resonant capacitor Cr and the output capacitor Co are located between the two upper switches. The projection of the output capacitor region 211 on the second surface 102 on the first surface partially coincides or completely coincides with the output capacitor region 111 on the first surface 101. The projection of the resonant capacitor region 214 provided on the second surface 102 partially coincides with or completely coincides with the resonant capacitor region 114 on the first surface 101. The projection of the input capacitor Cin on the first surface 101 on the first surface partially coincides with or completely coincides with the projection of the input capacitor Cin provided on the second surface 102 on the first surface.

The middle switch driving unit 42 as shown in FIG. 3A is respectively arranged in the middle switch driving areas 121 and 122, and is respectively adjacent to the middle switches Q2 and Q4; the upper switch driving unit 43 is respectively arranged in the middle-upper switch driving areas 121 and 122 and is respectively adjacent to the upper switches Q1 and Q3. The lower switch driving unit 41 and the driving magnetic piece 44 are arranged in the lower switch driving region 120 and 220. As shown in FIGS. 6C and 6D, the circuit substrate 10 further comprises a hole 71 and a hole groove 72. The hole 71 and the hole groove 72 penetrate through the lower switch driving region 120 of the first surface 101 and the lower switch driving region 220 of the second surface 102. The driving unit 41 further comprises a driving magnetic core 80. The driving magnetic core 80 comprises two driving magnetic substrates 81 and 82 and two driving side columns 83 and 84, the periphery of the hole 71 is surrounded by the circuit substrate, at least one side of the hole groove 72 is open, and the remaining side surfaces are surrounded by the circuit substrate The design of the hole groove 72/73/74 can reduce the occupancy of the surface area of the circuit substrate 10 as much as possible and reduce the size of the power conversion device. In another embodiment, the hole groove 72 may also be designed as a hole, like the hole 71. The driving side columns 83 and 84 respectively penetrate through the corresponding holes 71 and the hole grooves 72, and are buckled with the two driving magnetic substrates 81 and 82. On the circuit substrate 10, a part of the circuit substrate between the hole 71 and the hole groove 72 is used for arranging the windings W31 and W41 to W44 of the driving magnetic piece 44, and the winding method of the windings W31 and W41 to W44 of the driving magnetic piece 44 is not limited.

The circuit substrate 10 further comprises a slot 70 penetrating through the first surface 101 and the second surface 102 of the circuit substrate, and the slot 70 is arranged in the port areas 110 and 210. The system mainboard comprises a protrusion (not shown) corresponding to the slot 70. When the power conversion device is fixed to the system mainboard, the slot 70 is buckled with the protrusion, so that the power conversion device is convenient to assemble and install on the system mainboard, and furthermore, the fixing strength of the power conversion device and the system mainboard installation can be enhanced.

According to the transformer magnetic core 20 or the magnetic column (the side column and the middle column) in the driving magnetic core 80, the magnetic column (the side column and the middle column) can be independently formed, the magnetic column can be integrally formed with one magnetic substrate, or each magnetic column is divided into two parts, and each part is integrally formed with one magnetic substrate; and the transformer magnetic core material and the driving magnetic core material can be made of ferrite. The cross section, connected with the magnetic substrate, of the transformer magnetic core 20 or the magnetic column for driving the magnetic core 80 and the cross section of the magnetic substrate can be rectangular, square, circular, oval and the like, and are not limited thereto. The switch disclosed by the application can be used for realizing the functions of the switch disclosed by the application, such as Si MOSFET, SiC MOSFET, GaN MOSFET or IGBT MOSFET etc, the function of the switch disclosed by the application can be realized.

The power conversion device can be part of the electronic device or an independent power supply module as long as the technical features and advantages disclosed by the application can be met.

The “equal” or “same” or “equal to” disclosed by the application needs to consider the parameter distribution of engineering, and the error distribution is within +/−30%; the two line segments or the two straight lines are defined as the two line segments or the included angle between the two line segments or the two straight lines is less than or equal to 45 degrees; the included angle between the two line segments or the two straight lines is within the range of [60, 120]; and the definition of the phase error phase also needs to consider the parameter distribution of the project, and the error distribution of the phase error degree is within +/−30%.

What is claimed is:

1. A power conversion device, comprising: a circuit substrate, a transformer assembly, a switch, an output capacitor, an input positive end, an output positive end and an output negative end,
wherein the circuit substrate comprises a first surface and a second surface which are opposite to each other, and the first surface comprises a transformer area, a switch area, an output capacitor area and a first port area,
wherein the transformer assembly is arranged in the transformer area, the switch is arranged in the switch area, at least one part of the output capacitor is arranged in the output capacitor area, and the input positive end, the output positive end and the output negative end are arranged in the first port area,
wherein the transformer area, the switch area, the output capacitor area and the first port area are arranged in the same direction.

2. The power conversion device of claim 1, wherein the output positive end comprises at least two output positive-end gold fingers, the output negative end comprises at least two output negative-end gold fingers, and the at least two output positive-end gold fingers and the at least two output negative-end gold fingers are arranged in the first port area in a staggered mode.

3. The power conversion device of claim 1, further comprising: a signal end, wherein the signal end comprises at least two signal end gold fingers, and the at least two signal end gold fingers are arranged on one side of the first port area.

4. The power conversion device of claim 1, wherein the switch comprises two middle switches and two lower switches, the two lower switches are arranged between the two middle switches, and the middle switches and the lower switches are arranged adjacent to the transformer area.

5. The power conversion device of claim 4, wherein the switch further comprises two upper switches, and the two upper switches are respectively arranged adjacent to one of the two middle switches.

6. The power conversion device of claim 5, further comprising: a lower switch driving area and two middle-upper switch driving areas, wherein the two middle-upper switch driving areas are arranged on two opposite sides of the switch area respectively and are adjacent to the two middle switches and/or the two lower switches.

7. The power conversion device of claim 6, further comprising: a driving unit, wherein the driving unit comprises a driving magnetic piece, a lower switch driving unit, a middle switch driving unit and an upper switch driving unit, the driving magnetic piece and the lower switch driving unit are arranged in the lower switch driving area, and the middle switch driving unit and the upper switch driving unit are arranged in the middle-upper switch driving area.

8. The power conversion device of claim 2, wherein the second surface comprises a signal area and a second port area, and the at least two output positive-end gold fingers and the at least two output negative-end gold fingers are arranged in the second port area of the second surface in a staggered mode, wherein at least one of the at least two output positive-end gold fingers arranged on the second surface at least partially coincides with at least one of the at least two corresponding output positive-end gold fingers arranged on the first surface; and at least one of the at least two output negative-end gold fingers arranged on the second surface at least partially coincides with at least one of the at least two corresponding output negative-end gold fingers arranged on the first surface.

9. The power conversion device of claim 4, wherein the second surface comprises a switch region, the switch further comprises two other middle switches and two other lower switches, the two other middle switches and the two other lower switches are arranged in the switch region of the second surface, and a projection of the at least one of the two other two middle switches or the two other lower switches of the switch region of the second surface on the first surface at least partially coincides with a projection of one of the two corresponding middle switches or one of the two corresponding lower switches arranged on the first surface on the first surface.

10. The power conversion device of claim 1, wherein the second surface comprises an output capacitor area, at least a part of the output capacitor is arranged in the output capacitor area of the second surface, and a projection of the output capacitor arranged on the second surface is partially or completely in the output capacitor area of the first surface.

11. The power conversion device of claim 9, wherein at least one of the first surface and the second surface comprises a resonant capacitor area, and the resonant capacitor area is adjacent to one of two middle switches of the switch or one of two upper switches of the switch.

12. A power conversion device, comprising: a power conversion circuit, a driving unit and a control signal,
wherein the power conversion circuit comprises an input positive end, an input negative end, an output positive end and an output negative end, and the input negative end and the output negative end are short-circuited, wherein the power conversion circuit comprises a three-switch bridge arm, the three-switch bridge arm comprises a first upper switch, a first middle switch and a first lower switch which are electrically connected in series, the first upper switch is electrically connected with the input positive end, the first upper switch and the first middle switch are electrically connected to a first upper node, and the first middle switch and the first lower switch are electrically connected to a first lower node, wherein the power conversion circuit further comprises a second lower switch, and the first lower switch and the second lower switch are electrically connected with the input negative end,
wherein the control signal comprises a first control signal, a second control signal, a third control signal and a fourth control signal,
wherein the driving unit comprises a driving magnetic piece, an upper switch driving unit, a middle switch driving unit and a lower switch driving unit, wherein the lower switch driving unit receives the first control signal, the second control signal, the third control signal and the fourth control signal, wherein the lower switch driving unit outputs a lower switch driving signal for driving the first lower switch and the second lower switch to be turned-on and turned-off, and the lower switch driving unit is electrically connected with the driving magnetic piece, wherein the middle switch driving unit receives the control signal through the driving magnetic piece, and the middle switch driving unit outputs a middle switch driving signal to drive the first middle switch and the second middle switch to be turned-on and turned-off, and the upper switch driving unit receives the control signal through the driving magnetic piece, and the upper switch driving unit outputs an upper switch driving signal to drive the first upper switch and the second upper switch to be turned-on and turned-off.

13. The power conversion device of claim 12, wherein the lower switch driving unit comprises a driving power supply positive end, a grounding end, a first lower switch driving output end and a second lower switch driving output end, the lower switch driving unit further comprises four control switches, the four control switches are electrically connected into a full-bridge structure and are bridged between the driving power supply positive end and the grounding end, and the first lower switch driving output end and the second lower switch driving output end are respectively two bridge arm midpoints, and the four control switches are respectively controlled by the first control signal, the second control signal, the third control signal and the fourth control signal.

14. The power conversion device of claim 13, wherein the driving magnetic piece comprises a driving winding, a first middle winding and a first upper winding, the driving winding, the first middle winding and the first upper winding are wound on the same magnetic core, and the driving winding is bridged between the first lower switch driving output end and the second lower switch driving output end.

15. The power conversion device of claim 14, wherein the middle switch driving unit comprises two middle driving switches, drains of the two middle driving switches are electrically connected with two ends of the first middle winding respectively, and sources of the two middle driving switches are short-circuited to the first lower node, wherein one end of the first middle winding and the first lower node form a first middle switch driving output end, wherein and a voltage between any end of the first middle winding and the first lower node is used for controlling any of the two middle driving switches electrically connected with the other end of the first middle winding.

16. The power conversion device of claim 14, wherein the upper switch driving unit comprises two upper driving switches, drains of the two upper driving switches are electrically connected with two ends of the first upper winding respectively, and sources of the two upper driving switches are connected to the first upper node, wherein one end of the first upper winding and the first upper node form a first upper switch driving output end, and a voltage between any end of the first upper winding and the first upper node is used for controlling any of the two upper driving switches electrically connected with the other end of the first upper winding.

17. A power conversion device, comprising: a power conversion circuit, a pre-charging unit, a sampling resistor and a sampling circuit unit,
wherein the power conversion circuit comprises an input positive end, an input negative end, an output positive end, an output negative end and an output capacitor, the input negative end and the output negative end are short-circuited, and the output capacitor is bridged between the output positive end and the output negative end,
wherein the sampling circuit unit is used for sampling a working current of the power conversion circuit,
wherein the pre-charging unit comprises a switch end, an inductor end and a grounding end, the switch end is electrically connected with the input positive end, the inductor end is electrically connected with the output positive end through the sampling resistor, and the grounding end is electrically connected with the input negative end, wherein the pre-charging unit pre-charges the output capacitor,
wherein the sampling resistor is used for sampling an outflow current of the pre-charging unit.

18. The power conversion device of claim 17, wherein that the power conversion circuit further comprises two lower switches and two low-voltage windings, wherein first ends of the two low-voltage windings are electrically connected to the output positive end, and a second end of each of the two low-voltage windings is electrically connected with one end of one of the two lower switches to form two lower nodes; and the other end of the two lower switches is electrically connected to the output negative end.

19. The power conversion device of claim 18, wherein the sampling circuit unit comprises three sampling ends, a reference end, a sampling output positive end and a sampling output negative end, two sampling ends of the three sampling ends are electrically connected with a corresponding lower node, the other sampling end of the three sampling ends is electrically connected with the output positive end, and the reference end is electrically connected with the output positive end.

20. The power conversion device of claim 19, wherein the sampling circuit unit further comprises three sampling resistors, a sampling capacitor, an impedance matching resistor and an amplifying unit, wherein first ends of the three sampling resistors are electrically connected to a midpoint of the three sampling resistors, and a second end of each of the three sampling resistors is electrically connected with one sampling end, wherein the sampling capacitor and the impedance matching resistor are electrically connected between the reference end and the midpoint of the three sampling resistors in series, wherein the amplifying unit comprises two input ends and two output ends, the two input ends are electrically connected with the two ends of the sampling capacitor respectively, and the two output ends are electrically connected with the sampling output positive end and the sampling output negative end respectively.

21. The power conversion device of claim 17, wherein the pre-charging unit further comprises two pre-charging switches, a pre-charging inductor, a pre-charging capacitor and a pre-charging diode, wherein the two pre-charging switches are electrically connected in series between the switch end and the grounding end, wherein one end of the pre-charging inductor is electrically connected with a series connection point of the two pre-charging switches, and the other end of the pre-charging inductor is electrically connected with a positive electrode of the pre-charging diode and a positive end of the output capacitor, wherein a negative electrode of the pre-charging diode is electrically connected with the inductor end, and a negative end of the output capacitor is electrically connected with the grounding end.

22. The power conversion device of claim 17, wherein when a terminal voltage across the output capacitor reaches a predetermined voltage, the pre-charging unit stops working, and the predetermined voltage is greater than 70% of an output steady-state voltage of the power conversion circuit.

23. A power conversion device, comprising: a power conversion circuit, a controller, a gating circuit, a current sharing circuit unit, an address circuit unit and a starting control signal,
wherein the gating circuit comprises two input ends, a control end and an output end, the two input ends are electrically connected with the current sharing circuit unit and the address circuit unit respectively, the output end is electrically connected with the controller, and the control end receives the starting control signal,
wherein the controller is used for controlling the power conversion circuit,
wherein the starting control signal controls the gating circuit, and a voltage of the current sharing circuit unit or a voltage of the address circuit unit is sent to the controller through the gating circuit.

24. The power conversion device of claim 23, further comprising: a current source,
wherein when the starting control signal is at a low level, the current source charges the address circuit unit, and the voltage of the address circuit unit is sent to the controller through the gating circuit,
wherein when the starting control signal is at a high level, the current source charges the current sharing circuit unit, and the voltage of the current sharing circuit unit is sent to the controller by means of the gating circuit.

25. The power conversion device of claim 23, further comprising: a grounding end, wherein the current sharing circuit unit comprises a current sharing resistor, a current sharing capacitor and a current sharing switch, wherein the current sharing resistor and the current sharing capacitor are electrically connected between one input end of the gating circuit and the current sharing switch in parallel, one end of the current sharing switch is electrically connected with the grounding end, and the other end of the current sharing switch is electrically connected with the current sharing resistor and the current sharing capacitor, and the current sharing switch is controlled by the starting control signal.

26. The power conversion device of claim 23, further comprising: a grounding end, wherein the address circuit unit comprises an address resistor and an address capacitor, and the address resistor and the address capacitor are electrically connected in parallel between one input end of the gating circuit and the grounding end.

27. A power conversion device, comprising: a power conversion circuit, a dummy load unit, a power supply voltage and a dummy load control signal,
wherein the power conversion circuit comprises an input positive end, an input negative end, an output positive end and an output negative end, and the input negative end and the output negative end are short-circuited,
wherein the power conversion circuit further comprises an input capacitor and an output capacitor, the input capacitor is bridged between the input positive end and the output positive end, and the output capacitor is bridged between the output positive end and the output negative end,
wherein one end of the dummy load unit is electrically connected to the power supply voltage, and the other end is electrically connected to the output positive end,
wherein the dummy load control signal controls the dummy load unit to discharge the output positive end.

28. The power conversion device of claim 27, wherein when the dummy load control signal is at a low level, the dummy load unit is switched into the power conversion device, and when the dummy load control signal is at a high level, the dummy load unit is cut out from the power conversion device.

29. The power conversion device of claim 28, further comprising: a starting control signal and a preset voltage, wherein when the starting control signal of the power conversion device is at the high level, the dummy load control signal is at the high level, wherein when the starting control signal of the power conversion device is at the low level and the output voltage of the power conversion device is greater than or equal to the preset voltage, the dummy load control signal is at the high level, and when the starting control signal of the power conversion device is at the low level, and the output voltage of the power conversion device is smaller than the preset voltage, the dummy load control signal is at the low level.

30. The power conversion device of claim 27, wherein the dummy load unit comprises a power supply end, a grounding end, a first dummy load control switch, a second dummy load control switch, a dummy load amplifying switch, a first current limiting resistor, a second current limiting resistor, a third current limiting resistor and a fourth current limiting resistor, wherein the first current limiting resistor and the first dummy load control switch are connected in series between the power supply end and the grounding end, and a gate electrode of the first dummy load control switch is electrically connected with the dummy load control signal, wherein the second current limiting resistor, the second dummy load control switch and the third current limiting resistor are connected in series between the power supply end and the grounding end, and a gate electrode of the second dummy load control switch is electrically connected with a drain electrode of the first dummy load control switch, wherein the dummy load amplifying switch and the fourth current limiting resistor are connected in series between the output positive end and the grounding end of the power conversion device, and a base electrode of the dummy load amplifying switch is electrically connected with the source electrode of the second dummy load control switch.

31. The power conversion device of claim 27, wherein the dummy load unit comprises a dummy load amplifying switch and a current limiting resistor, the dummy load amplifying switch is electrically connected to an output positive end of the power conversion device, the dummy load control signal is used for controlling the dummy load amplifying switch to be turned on and turned off, and the current limiting resistor is used for controlling the current flowing through the dummy load amplifying switch.
